(19) United States
(12) Patent Application Publication
(10) Pub. No.: US 2016/0226894 A1
(43) Pub. Date: Aug. 4, 2016

(54) SYSTEM AND METHOD FOR DETECTING INTRUSION INTELLIGENTLY BASED ON AUTOMATIC DETECTION OF NEW ATTACK TYPE AND UPDATE OF ATTACK TYPE MODEL

(71) Applicant: ELECTRONICS AND TELECOMMUNICATIONS RESEARCH INSTITUTE, Daejeon (KR)

(72) Inventors: Han Sung LEE, Daejeon (KR); Ig Kyun KIM, Daejeon (KR); Dae Sung MOON, Daejeon (KR); Min Ho HAN, Daejeon (KR)

(21) Appl. No.: 14/996,505

(22) Filed: Jan. 15, 2016

(30) Foreign Application Priority Data
Feb. 4, 2015 (KR) 10-2015-0017334

(51) Int. Cl. H04L 29/06; G06N 99/00

(52) U.S. Cl. CPC H04L 63/1416; H04L 63/1425; G06N 99/005

(57) ABSTRACT

Disclosed are a method and system, capable of performing adaptive intrusion detection proactively coping with a new type of attack unknown to the system and capable of training an intrusion type classification model by using a small volume of training data, the system including a data collector configured to collect host and network log information, an input data preprocessor configured to convert data acquired through the data collector into a feature vector, which is an input type of intelligence intrusion detection, and an intelligence intrusion detection analyzer configured to perform an intrusion detection and a model update by using the extracted feature vector, and an intrusion detection learning model configured to detect an intrusion and learn classification of the type of attack based on training data.

### CROSS-REFERENCE TO RELATED APPLICATION

This application claims priority to and the benefit of Korean Patent Application No. 2015-0017334, filed on Feb. 4, 2015, the disclosure of which is incorporated herein by reference in its entirety.

### BACKGROUND

1. Field of the Invention

The present invention relates to a system for detecting an attack on computer resources connected to a network and a method thereof, and more particularly, to a system for detecting whether data acquired through a network is normal data or abnormal attack data, and responding to the result of the detection, and a method thereof.

2. Discussion of Related Art

With development of network and computer technologies, there has been increase of attacks on computer resources connected to a network. The attacks have recently taken place in various manners, for example, emergence of advanced persistent threat (APT) which is carried out with a specific purpose over a long period based on vulnerability of the network and computer resources.

The conventional method for detecting an intrusion on computer resources is largely divided into a misuse detection and an anomaly detection.

The misuse detection precisely detects an attack and also provides precise information about the type of an attack, so that an appropriate response to the attack can be taken. However, the misuse detection has difficulty in responding to a new type of attack unknown to a system.

On the other hand, the anomaly detection operates to define a model with respect to a normal behavior and monitor behaviors deviated from the normal behavior and classify the behaviors as abnormal behaviors, thereby coping with a new type of attack unknown to a system. However, the anomaly detection has difficulty in providing additional information that allows a system to handle the attack, for example, information about the type of the detected attack.

In order to overcome the above-described drawbacks of the conventional intrusion detection method, various theses have suggested intrusion detection methods using an adaptive intrusion detection method and a data mining-based method.

The theses (H. Lee, J. Song, and D. Park, “Intrusion Detection System Based on Multi-Class SVM,” LNAI, pp. 511-519, 2005 and J. Yu, H. Lee, M. Kim, and D. Park, “Traffic Flooding Attack Detection with SNMP MIB using SVM,” Computer Communications, vol. 31, no. 17, pp. 4212-4219, 2008) have suggested methods for enhancing the advantages while removing the disadvantages disclosed in the misuse detection and the anomaly detection.

According to the suggested methods, the type of an attack unknown to a system is detected through an anomaly detection, but the attack data detected through the anomaly detection is classified into previously defined categories by using a supervised classifier and detail types of attack are classified through unsupervised clustering.

That is, the suggested methods can detect a new attack unknown to a system, but there is a burden to classify the detected attack into one of predefined types. Accordingly, the methods can detect a new attack unknown to a system, but have difficulty in determining whether the attack belongs to a new type of attack.

In addition, the suggested methods require a great volume of training data to train a classifier. However, in many cases, when a new type of attack is found, it is not easy to acquire a great volume of training data sufficient to learn a new class.

Accordingly, there is an increasing demand for an intelligence intrusion detection system and a method thereof, capable of performing adaptive intrusion detection proactively coping with a new type of attack and capable of training a classifier model using a small volume of training data.

### SUMMARY OF THE INVENTION

The present invention is directed to a method for detecting a new attack unknown to an intrusion detection system, automatically determining whether the detected attack belongs to an existing type of attack that is learned by the system, and automatically reflecting a type of attack unregistered in the system on the system.

The present invention is directed to an adaptive intrusion detection and learning method capable of detecting abnormal behavior and classifying the type of attack by using a small amount of training data, and an intelligence intrusion detection system using the same.

In accordance with an aspect of the present invention, an intelligence intrusion detection system includes: an input data preprocessor and an intelligence intrusion detection analyzer. The input data preprocessor may be configured to convert data acquired through a data collector into a feature vector. The intelligence intrusion detection analyzer may be configured to detect whether the acquired data is abnormal attack data by using the converted feature vector, check whether the acquired data belongs to a new type of attack if the acquired data is detected as abnormal attack data, and update a prestored abnormal attack model.

The intelligence intrusion detection analyzer may include an abnormality detection module configured to detect whether the acquired data is abnormal attack data by using the converted feature vector, an attack type classification module configured to classify a type of attack of the detected abnormal attack data detected by the abnormality detection module, and determine whether the abnormal attack data belongs to a new type of attack based on a result of the classification of the abnormal attack data, and a model update module configured to update at least one of prestored training data and the prestored abnormal attack model according to a result of the detection by the abnormality detection module or a result of the classification by the attack type classification module.

The abnormality detection module may generate a normal profile using an ellipsoid defined in a feature space with respect to the acquired data, and detect whether the acquired data is abnormal attack data.

The abnormality detection module, in a training phase of learning normal data, may extract principal components of the feature space with respect to the acquired data, generate a feature vector mapped onto the feature space by using the extracted principal components, and generate a profile about the normal data by use of the mapped feature vector.

The abnormality detection module, in a test phase of detecting whether the acquired data is abnormal attack data, may generate a feature vector in the feature space by projecting the converted feature vector onto the principal component calculated in the training phase, and detect whether the acquired data is abnormal attack data.

If the acquired data is checked as abnormal attack data by the abnormality detection module, the attack type classification module may calculate a similarity with the prestored abnormal attack model to determine whether the acquired data belongs to a new type of attack.

If a similarity between the acquired data and all of prestored abnormal attack models is equal to or smaller than a preset value, the attack type classification module may determine that the abnormal attack data belongs to a new type of attack.

If the abnormal attack data does not belong to a new type of attack, the model update module may check whether the acquired data is similar to the prestored training data, and update the abnormal attack model.

If the abnormal attack data belongs to a new type of attack, the model update module may add the new type of attack to the prestored abnormal attack model, and perform relearning of the acquired data.

If the acquired data is checked as abnormal attack data, the attack type classification module may determine whether the abnormal attack data is a new type of attack by using a subspace-based learning.

If the acquired data is checked as normal data by the abnormality detection module, the model update module may check whether the normal data overlaps the prestored training data, and if the normal data does not overlap the prestored training data, update a normal data model.

The model update module may calculate a similarity between the acquired data and the prestored training data, and if the calculated similarity is equal to or smaller than a preset value, determine that the acquired data does not overlap the prestored training data.

In accordance with another aspect of the present invention, an intelligence intrusion detection method includes: converting data acquired through a data collector into a feature vector; detecting whether the data is abnormal attack data by using the converted feature vector; and classifying a type of attack of the data and updating a prestored abnormal attack model, if the data is abnormal attack data.

In the detecting of whether the data is abnormal attack data by using the converted feature vector, principal components of a feature space with respect to the data may be extracted, a profile about normal data may be generated by use of the extracted principal components, and whether the data is abnormal attack data may be detected.

The classifying of a type of attack of the data and updating of the prestored abnormal attack model, if the data is abnormal attack data may include: determining whether the abnormal attack data belongs to a new type of attack; and if the abnormal attack data belongs to a new type of attack, adding the new type of attack to the abnormal attack model, and performing relearning of the acquired data.

The classifying of a type of attack of the data, and updating of the prestored abnormal attack model, if the data is abnormal attack data may include: if the abnormal attack data does not belong to a new type of attack, determining whether the abnormal attack data overlaps abnormal attack data that has previously participated in a training process, and if the abnormal attack data does not overlap the abnormal attack data that has previously participated in the training process, updating the abnormal attack model.

In the determining of whether the abnormal attack data belongs to a new type of attack, a similarity between the abnormal attack data and the prestored abnormal attack model may be calculated, and if the calculated similarity is equal to or smaller than a preset value, the abnormal attack data may be determined to belong to a new type of attack.

In the classifying of a type of attack of the data and updating of the prestored abnormal attack model, if the data is abnormal attack data, the type of attack of the abnormal attack data may be classified by use of a subspace-based learning.

The intelligence intrusion detection method may further include, if the data is normal data, determining whether the data overlaps normal data that has previously participated in a training process, and if the data does not overlap the normal data that has previously participated in the training process, updating a normal data model.

The converting of data acquired through the data collector into a feature vector may include acquiring the data from at least one of a host data collector, a network data collector and legacy equipment.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating the configuration of an intelligence intrusion detection system according to an exemplary embodiment of the present invention;

FIG. 2 is a detailed view illustrating the configuration of an intelligence intrusion detection analyzer and an intrusion detection learning model shown in FIG. 1; and

FIGS. 3A to 3F are views illustrating boundary surfaces for decision of normal data detected by an intelligence intrusion detection system according to an exemplary embodiment of the present invention.

FIG. 4 is a block diagram illustrating a computer system to which the present invention is applied.

### DETAILED DESCRIPTION OF EXEMPLARY EMBODIMENTS

The advantages and features of the present invention, and methods of accomplishing the same, will become readily apparent with reference to the following detailed description and the accompanying drawings. However, the scope of the present invention is not limited to embodiments disclosed herein, and the present invention may be realized in various forms. The embodiments to be described below are provided merely to fully disclose the present invention and assist those skilled in the art in thoroughly understanding the present invention. The present invention is defined only by the scope of the appended claims.

Meanwhile, the terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. Hereinafter, exemplary embodiments of the present invention will be described in detail with reference to the accompanying drawings.

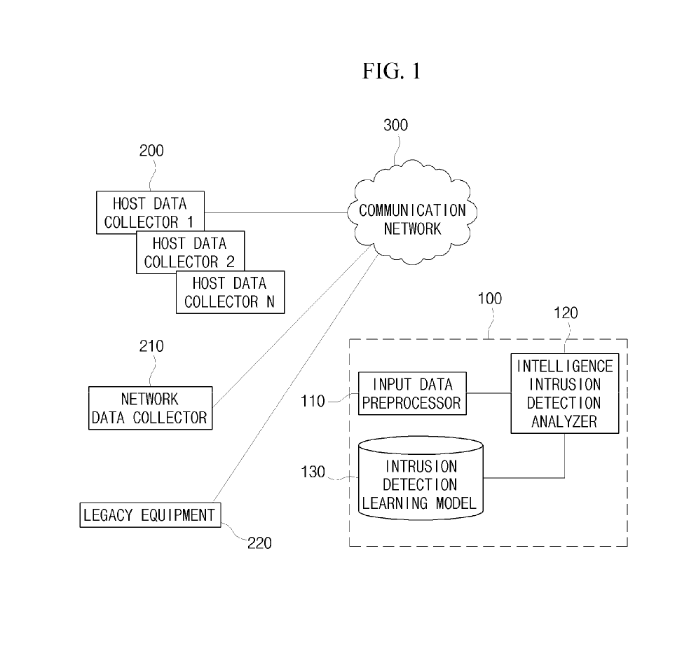

FIG. 1 is a block diagram illustrating the structure of an intelligence intrusion detection system 100 according to an exemplary embodiment of the present invention.

The intelligence intrusion detection system 100 according to an exemplary embodiment of the present invention includes an input data preprocessor 110, an intelligence intrusion detection analyzer 120 and an intrusion detection learning model 130.

The input data preprocessor 110 receives data collected from a host data collector 200, a network data collector 210 and legacy equipment 220, such as a firewall and an intrusion prevention system, through a communication network 300, and extracts a feature vector to apply an intrusion detection algorithm to the collected data. The host data collector 200 and the network data collector 210 may be each provided as individual hardware, or may be provided as single hardware if necessary.

The input data preprocessor 110 parses the collected data, and coverts the parsed data into a feature vector that is input to the intelligence intrusion detection analyzer 120. The converted feature vector may take various forms in consideration of characteristics and detection range of each data.

The intelligence intrusion detection analyzer 120 performs analysis whether the collected data is normal data or abnormal attack data by use of the feature vector extracted from the input data preprocessor 110, and updates prestored training data and a prestored abnormal attack model according to a result of the analysis. The updated training data and the updated abnormal attack model are stored in the intrusion detection learning model 130.

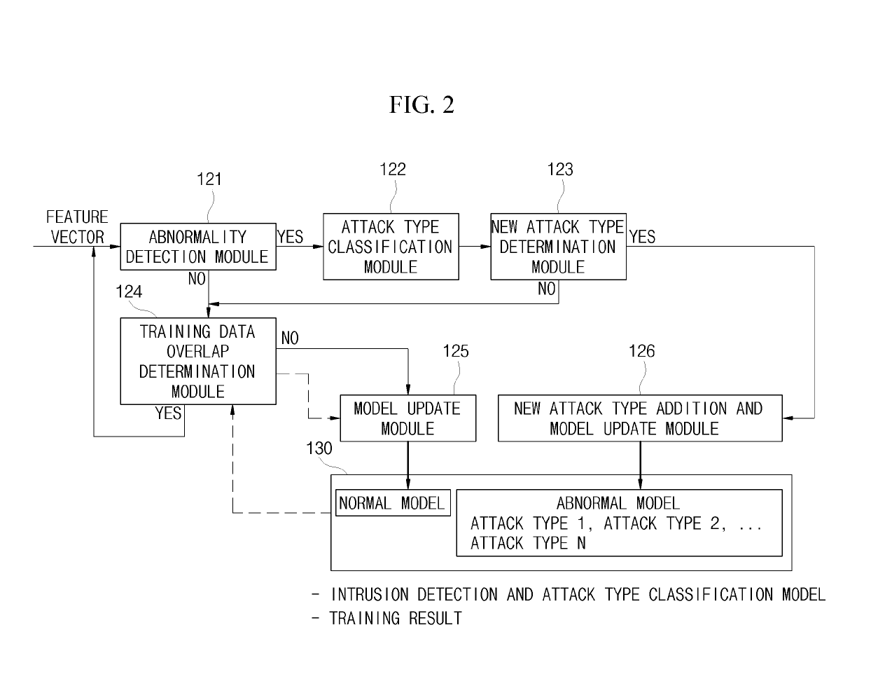

FIG. 2 is a detailed view illustrating a configuration of the intelligence intrusion detection analyzer 120 and the intrusion detection learning model 130. The intelligence intrusion detection analyzer 120 includes an abnormality detection module 121, an attack type classification module 122, a new attack type determination module 123, a training data overlap determination module 124, a model update module 125 and a new attack type addition and model update module 126. The intrusion detection learning model 130 stores training data of a normal model, a model type of an abnormal attack model, and training data.

The abnormality detection module 121, upon receiving a feature vector from the input data preprocessor 110, determines whether the feature vector is attack data or normal data by use of one of generally known abnormal attack data detection methods.

The abnormality detection module 121 may use Support Vector Data Description (SVDD), an example of one-class Support Vector Machine, to detect abnormal attack. However, in order to further precisely detect abnormal attack data, the abnormality detection module 121 according to the present invention detects abnormal attack data by generating a normal profile using an ellipsoid defined in a feature space, and using the generated normal profile.

The abnormality detection module 121 performs a training process to learn normal data and a test process to detect whether actual data is abnormal (whether attack occurs). The following description will be made on a process of the abnormality detection module 121 detecting abnormal attack data by using the normal profile.

In the training process, the abnormality detection module 121 performs principal component analysis in a feature space with respect to training data. The principal component analysis in the feature space includes obtaining a covariance matrix in the feature space according to Equation 1 below, and extracting principal components according to Equations 2 and 3 below.

Given a set of n-training data points mapped onto a feature space, Φ(x)={Φ(xᵢ)εF}ᵢ₌₁ⁿ, the covariance matrix in a kernel feature space is defined as follows:

$$\begin{matrix}{C}^{Φ} = \frac{1}{n} {\sum }_{j = 1}^{n} Φ ( {x}_{j} ) {Φ ( {x}_{j} )}^{T} & [ Equation 1 ] \\ λ ( Φ ( {x}_{k} ) \cdot V ) = ( Φ ( {x}_{k} ) \cdot {C}^{Φ} V ) , k = 1.2 . … , n & [ Equation 2 ]\end{matrix}$$

where λ≧0 are the eigenvalues, and V are eigenvectors, V=Σᵢ₌ⁿαᵢΦ(xᵢ).

By defining the n×n kernel matrix K as Kᵢⱼ=(Φ(xᵢ)·Φ(xⱼ)), the following equation is obtained:

nλα=Kα [Equation 3]

where α denotes the column vector with the entries α₁, α₂, . . . , αₙ.

The abnormality detection module 121 generates a feature vector mapped onto the feature space from the principal components extracted by the above described method, by using Equation 4 below.

For the principal component extraction, projections of the image for the training data points Φ(x) onto eigenvectors V^{k} in the feature space are computed.

\tilde{x}=(V^{k}·Φ(x))=Σᵢ₌₁ⁿαᵢ^{k}k(xᵢ,x) [Equation 4]

where k(x, y) is the kernel function.

By using data mapped onto the feature space and Equation 5 below, a profile of normal data is generated.

$$MVEE = \text{?} \tilde{x} ∈ ℱ \vert {( \tilde{x} - \text{?} )}^{T} \text{?} ( x - \text{?} ) \leq 1 \text{?} , \\ {\tilde{Q}}^{*} = \frac{1}{\text{?}} {( {PU}^{*} {P}^{T} - {{Pu}^{*} ( {Pu}^{*} )}^{T} )}^{- 1} , \\ \text{?} = {Pu}^{*} \\ \text{?} \text{indicates text missing or illegible when filed} \qquad [ Equation 5 ]$$

where P=[q₁, q₂, . . . , qₙ]εF, qᵢ^{T}=[\tilde{x}ᵢ^{T},1]; i=1, 2, . . . , n, u is the dual variable, and U=diag(u). The approximated optimal covariance matrix [symbol] and the center \tilde{x}*_{c} of the MVEE are obtained as the results of the training phase.

In the test phase, the abnormality detection module 121 determines whether an input feature vector is normal data or attack data. In this case, the abnormality detection module 121 projects the input feature vector onto the principal components calculated in the training phase by use of Equation 6, and generates a feature vector in the feature space. Thereafter, the abnormality detection module 121 determines whether the generated feature vector is normal data or attack data by using Equation 7 below.

\tilde{x}^{tst}=(V^{k}·Φ(x^{tst}))=Σᵢ₌₁ⁿaᵢ^{k}k(xᵢ^{trn},x^{tst}) [Equation 6]

where x^{trn} is a set of n-training data points, and V^{k}, α^{k} are obtained in the training phase.

f(x^{txt})=1+e−(xc^{tst}−x_{g}^{tst})^{T}\tilde{Q}^{x}(\tilde{x}^{tst}−\tilde{x}_{c}^{tst}) [Equation 7]

where [symbol] is the approximated optimal covariance matrix, and \tilde{x}*_{c} is the center of the minimum volume enclosing ellipsoid (MVEE), which are obtained from the training phase.

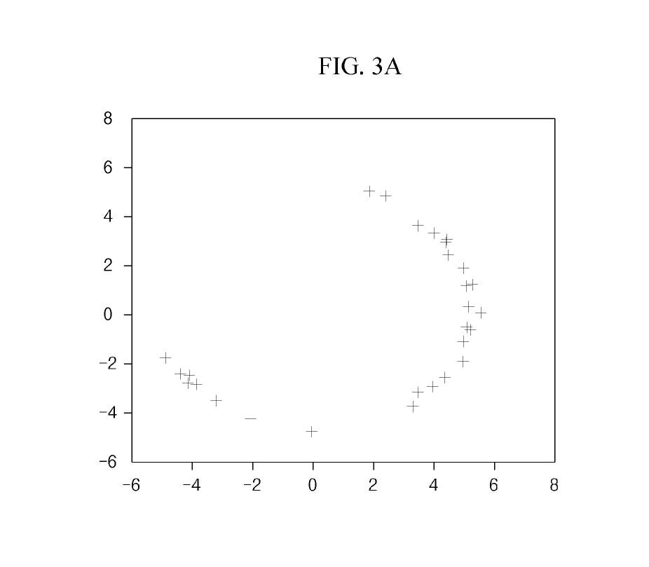

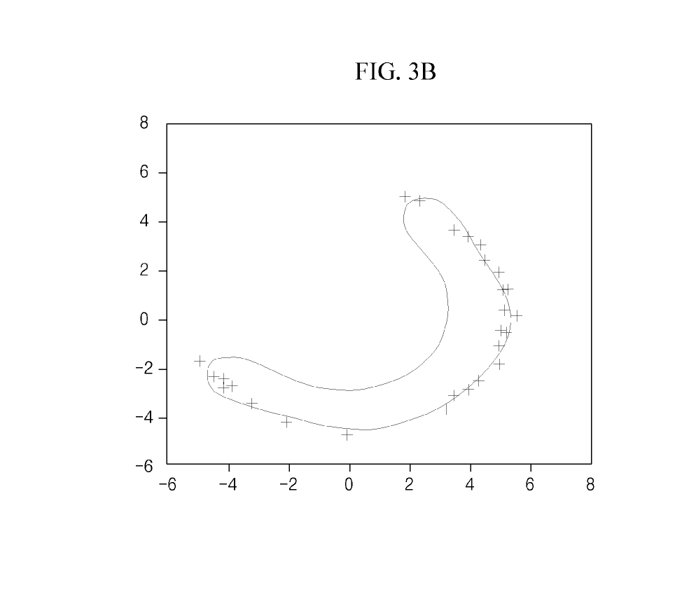

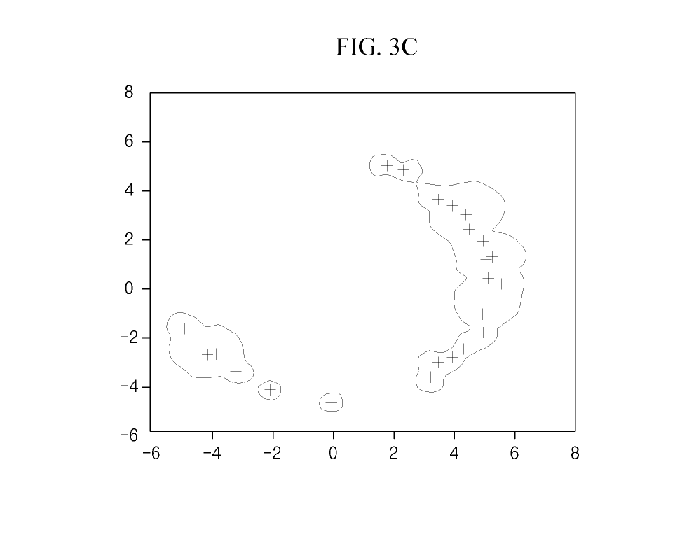

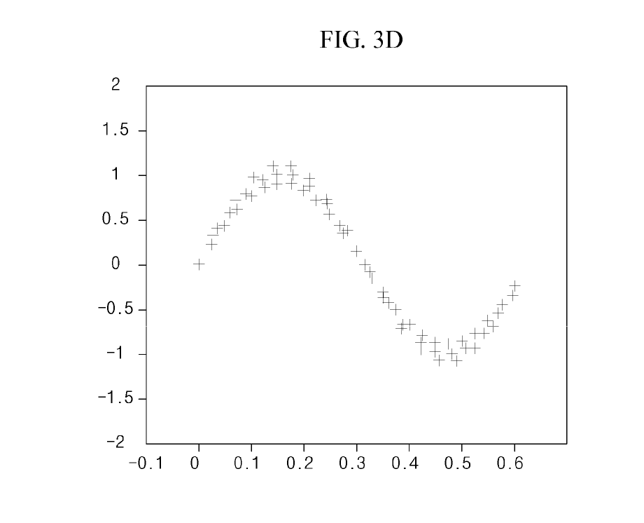

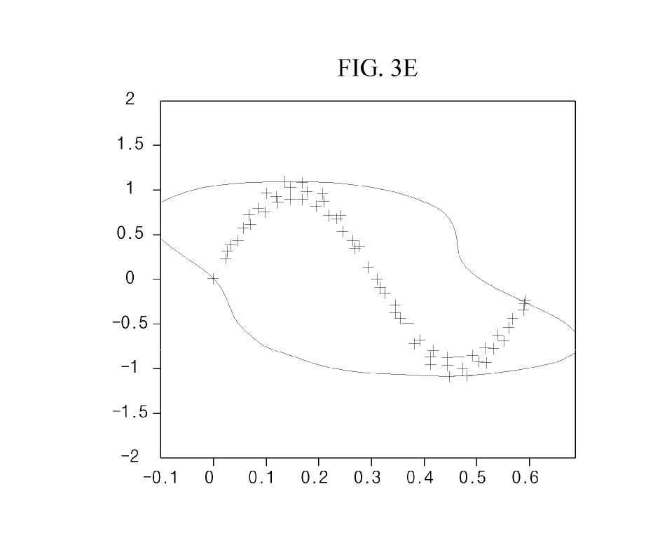

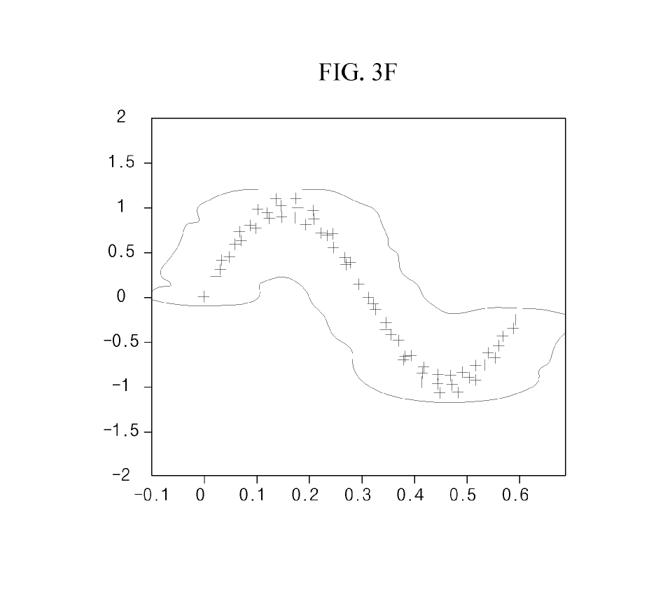

FIGS. 3A to 3F are views illustrating boundary surfaces for decision of normal data obtained by the SVDD described above and the method according to the present invention, in which FIGS. 3A and 3B illustrate data for a test process, FIGS. 3C and 3E illustrate decision boundaries found by the SVDD, and FIGS. 3D and 3F illustrate decision boundaries found by the method according to the present invention.

Referring to FIGS. 3A to 3F, the method according to the present invention generates a decision boundary more dense and balanced when compared to the method according to the SVDD.

As a result of the analysis of the abnormality detection module 121, if the input feature vector is determined as normal data, the training data overlap determination module 124 determines whether the normal data overlaps normal data that has previously participated in a training process.

For this, the training data overlap determination module 124 calculates a similarity between the input data and a plurality of pieces of data that have previously participated in a training process, and performs the determination depending on whether the smallest value of the calculated similarities is equal to or smaller than a preset value. That is, if the smallest similarity value is equal to or smaller than a preset value, the input data is determined as new data.

The training data overlap determination module 124, if the input data is redundant data, disposes the input data, and if the input data is not redundant data, allows the model update module 125 to update the normal model of the intrusion detection learning model 130.

The training data overlap determination module 124 may be configured to be included in the model update module 125.

As a result of the analysis of the abnormality detection module 121, if the input feature vector is determined as abnormal attack data, the attack type classification module 122 calculates a similarity between the input feature vector and the abnormal attack models of the intrusion detection learning model 130 that is previously learned by the system.

The new attack type determination module 123 determines whether the abnormal attack data is a new type of attack by using the similarity with the calculated prestored abnormal attack models.

As a result of the determination, if the input feature vector has a high similarity with a specific type of attack while having low similarities with the remaining types of attack, the input feature vector is determined as an existing type of attack, and if the input feature vector has low similarities with all types of attack, the input feature vector is determined as a new type of attack.

According to an exemplary embodiment of the present invention, in order to provide a basis for the new attack type determination module 123 to decide the type of attack, the attack type classification module 122 needs to use a classifier based on a similarity with each training data rather than using a general classification model. In addition, the attack type classification module 122 needs to use a classifier capable of performing learning and classification even if the amount of training data for each type of attack is small.

According to an exemplary embodiment of the present invention, the attack type classification module 122 may use a k-nearest neighbors (k-nn) classifier or a Sparse Representation Classifier (SRC) and may use subspace-based learning.

The k-nn classifier or SRC may provide a sufficient function required in the present invention. However, the k-nn classifier or SRC has difficulty in performing a prelearning by the nature of Lazy learner, and also uses training data directly, causing classification speed to be lowered. On the other hand, the subspace-based learning is able to perform prelearning, offering a higher classification speed. The subspace-based learning will be described below in detail.

In order to optimally represent each data by using a basis vector, data itself may be used as a basis vector, and representation of a type of attack may be also expressed by data itself. Given n-training data of m-dimensions, a matrix having each data as a column vector is generated as in Equation 8 below:

A=[v₁,v₂,v₃, . . . ,vₙ] [Equation 8]

where v1, v2, . . . , vn are training vectors.

When the training data is given, test data may be mapped onto a subspace represented by the column vector of the training data. The test data may be represented as a linear combination with respect to the column vectors of the training data A.

y=a₁v₁+a₂v₂+ . . . +aₙvₙ [Equation 9]

The mapping onto the column subspace may be defined as a problem to resolve a linear system of Equation 10.

Y=Axₒₚₜ, where x₀=[0,0, . . . a,ₖ₁,aₖ₂, . . . a,ₖₙ,0, . . . 0,0] [Equation 10]

That is, the test data obtains a solution that has a high coefficient value for a column vector of training data belonging to a specific type of attack while having a value approximately 0 for the remaining. When a subspace-based learning is performed, there is no need to limit the number of pieces of data for each type of attack if the column vector for each data is selected as a basis vector.

A solution to this problem is obtained through a classical approach to solve y=Ax. When a matrix of training data A is m×n, mapping xₒₚₜ of test data y onto a column subspace for classification of the type of attack is obtained as follows:

when Rank (A)=n, xₒₚₜ=(A^{T}A)⁻¹A^{T}y [Equation 11]

when Rank (A)=m, xₒₚₜ=A^{T}(AA^{T})⁻¹y [Equation 12]

If the input feature vector is determined as the existing type of attack by the new attack type determination module 123, the training data overlap determination module 124 determines whether the input feature vector overlaps abnormal attack data that has previously participated in a training process.

As a result of determination of the training data overlap determination module 124, if the input feature vector is determined as redundant data, the data is disposed, and if the input feature vector is not redundant data, the abnormal attack model of the intrusion detection learning model 130 is updated by the model update module 125.

If the input feature vector is determined as a new type of attack by the new attack type determination module 123, the new attack type addition and model update module 126 updates the abnormal attack model of the intrusion detection learning model 130 to reflect abnormal attack data determined as a new type of attack by the new attack type determination module 123, and performs relearning. The relearning method is the same as that described in Equations 11 and 12.

Alternatively, the new attack type determination module 123 may be included in the attack type classification module 122, and the new attack type addition and model update module 126 may be included in the model update module 125.

An embodiment of the present invention may be implemented in a computer system, e.g., as a computer readable medium.

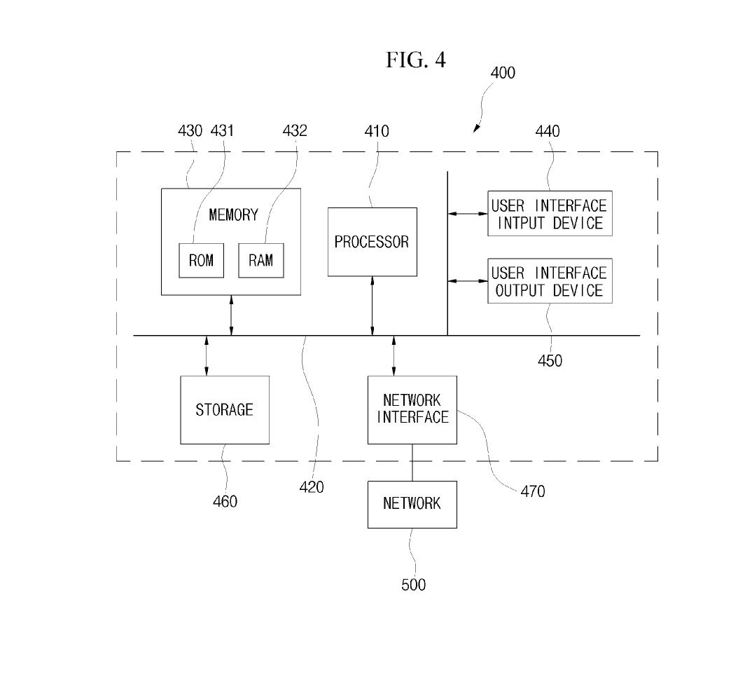

As shown in FIG. 4, a computer system 400 may include one or more of a processor 410, a memory 430, a user interface input device 440, a user interface output device 450, and a storage 460, each of which communicates through a bus 420. The computer system 400 may also include a network interface 470 that is coupled to a network 500. The processor 410 may be a central processing unit (CPU) or a semiconductor device that executes processing instructions stored in the memory 430 and/or the storage 460. The memory 430 and the storage 460 may include various forms of volatile or non-volatile storage media. For example, the memory 430 may include a read-only memory (ROM) 431 and a random access memory (RAM) 432.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As is apparent from the above, the intrusion detection system and method can detect a new type of attack unknown to the intrusion detection system, automatically determine whether the detected attack belongs to the existing type of attack that is learned by the system or belongs to a new type of attack, and automatically reflect a type of attack that is not registered in the system on the system, thereby providing a new model of an intelligence intrusion detection system capable of adaptively responding to a new type of attack and performing learning for itself.

In addition, the present invention provides an adaptive intrusion detection and learning method capable of detecting abnormal behavior and classifying the type of attack by using a small amount of training data, thereby removing constraints associated with the training data collection in the conventional machine learning-based intrusion detection method.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An intelligence intrusion detection system comprising:
an input data preprocessor configured to convert data acquired through a data collector into a feature vector; and
an intelligence intrusion detection analyzer configured to detect whether the acquired data is abnormal attack data by using the converted feature vector, check whether the acquired data belongs to a new type of attack if the acquired data is detected as abnormal attack data, and update a prestored abnormal attack model.

2. The intelligence intrusion detection system of claim 1, wherein the intelligence intrusion detection analyzer comprises:
an abnormality detection module configured to detect whether the acquired data is abnormal attack data by using the converted feature vector;
an attack type classification module configured to classify a type of attack of the detected abnormal attack data detected by the abnormality detection module, and determine whether the abnormal attack data belongs to a new type of attack based on a result of the classification of the abnormal attack data; and
a model update module configured to update at least one of prestored training data and the prestored abnormal attack model according to a result of the detection by the abnormality detection module or a result of the classification by the attack type classification module.

3. The intelligence intrusion detection system of claim 2, wherein the abnormality detection module generates a normal profile using an ellipsoid defined in a feature space with respect to the acquired data, and detects whether the acquired data is abnormal attack data.

4. The intelligence intrusion detection system of claim 3, wherein the abnormality detection module, in a training phase of learning normal data, extracts principal components of the feature space with respect to the acquired data, generates a feature vector mapped onto the feature space by using the extracted principal components, and generates a profile about the normal data by use of the mapped feature vector.

5. The intelligence intrusion detection system of claim 4, wherein the abnormality detection module, in a test phase of detecting whether the acquired data is abnormal attack data, generates a feature vector in the feature space by projecting the converted feature vector onto the principal component calculated in the training phase, and detects whether the acquired data is abnormal attack data.

6. The intelligence intrusion detection system of claim 2, wherein, if the acquired data is checked as abnormal attack data by the abnormality detection module, the attack type classification module calculates a similarity with the prestored abnormal attack model to determine whether the acquired data belongs to a new type of attack.

7. The intelligence intrusion detection system of claim 6, wherein if a similarity between the acquired data and all of prestored abnormal attack models is equal to or smaller than a preset value, the attack type classification module determines that the abnormal attack data belongs to a new type of attack.

8. The intelligence intrusion detection system of claim 6, wherein if the abnormal attack data does not belong to a new type of attack, the model update module checks whether the acquired data is similar to the prestored training data, and updates the abnormal attack model.

9. The intelligence intrusion detection system of claim 6, wherein if the abnormal attack data belongs to a new type of attack, the model update module adds the new type of attack to the prestored abnormal attack model, and performs relearning of the acquired data.

10. The intelligence intrusion detection system of claim 2, wherein if the acquired data is checked as abnormal attack data, the attack type classification module determines whether the abnormal attack data is a new type of attack by using a subspace-based learning.

11. The intelligence intrusion detection system of claim 2, wherein if the acquired data is checked as normal data by the abnormality detection module, the model update module checks whether the normal data overlaps the prestored training data, and if the normal data does not overlap the prestored training data, updates a normal data model.

12. The intelligence intrusion detection system of claim 11, wherein the model update module calculates a similarity between the acquired data and the prestored training data, and if the calculated similarity is equal to or smaller than a preset value, determines that the acquired data does not overlap the prestored training data.

13. An intelligence intrusion detection method comprising:
converting data acquired through a data collector into a feature vector;
detecting whether the data is abnormal attack data by using the converted feature vector; and
classifying a type of attack of the data and updating a prestored abnormal attack model, if the data is abnormal attack data.

14. The intelligence intrusion detection method of claim 13, wherein in the detecting of whether the data is abnormal attack data by using the converted feature vector, principal components of a feature space with respect to the data are extracted, a profile about normal data is generated by use of the extracted principal components, and whether the data is abnormal attack data is detected.

15. The intelligence intrusion detection method of claim 13, wherein the classifying of a type of attack of the data and updating of the prestored abnormal attack model, if the data is abnormal attack data comprises:
determining whether the abnormal attack data belongs to a new type of attack; and
if the abnormal attack data belongs to a new type of attack, adding the new type of attack to the abnormal attack model, and performing relearning of the acquired data.

16. The intelligence intrusion detection method of claim 15, wherein the classifying of a type of attack of the data, and updating of the prestored abnormal attack model, if the data is abnormal attack data comprises:
if the abnormal attack data does not belong to a new type of attack, determining whether the abnormal attack data overlaps abnormal attack data that has previously participated in a training process, and if the abnormal attack data does not overlap the abnormal attack data that has previously participated in the training process, updating the abnormal attack model.

17. The intelligence intrusion detection method of claim 15, wherein in the determining of whether the abnormal attack data belongs to a new type of attack, a similarity between the abnormal attack data and the prestored abnormal attack model is calculated, and if the calculated similarity is equal to or smaller than a preset value, the abnormal attack data is determined to belong to a new type of attack.

18. The intelligence intrusion detection method of claim 13, wherein in the classifying of a type of attack of the data and updating of the prestored abnormal attack model, if the data is abnormal attack data, the type of attack of the abnormal attack data is classified by use of a subspace-based learning.

19. The intelligence intrusion detection method of claim 13, further comprising, if the data is normal data, determining whether the data overlaps normal data that has previously participated in a training process, and if the data does not overlap the normal data that has previously participated in the training process, updating a normal data model.

20. The intelligence intrusion detection method of claim 13, wherein the converting of data acquired through the data collector into a feature vector comprises acquiring the data from at least one of a host data collector, a network data collector and legacy equipment.
